(19) United States
(12) Patent Application Publication
(10) Pub. No.: US 2021/0184801 A1
(43) Pub. Date: Jun. 17, 2021

(54) METHOD AND APPARATUS FOR HARQ-ACK CODEBOOK SIZE DETERMINATION AND RESOURCE SELECTION IN NR

(71) Applicant: IDAC HOLDINGS, INC., Wilmington, DE (US)

(72) Inventors: Aata El Hamss, Laval (CA); Paul Marinier, Brossard (CA); J. Patrick Tooher, Montreal (CA); Ghyslain Pelletier, Montreal (CA); Benoit Pelletier, Roxboro (CA)

(73) Assignee: IDAC HOLDINGS, INC., Wilmington, DE (US)

(21) Appl. No.: 16/764,693

(22) PCT Filed: Nov. 15, 2018
(86) PCT No.: PCT/US2018/061280

§ 371 Date: May 15, 2020

Related U.S. Application Data
(60) Provisional application No. 62/586,525, filed on Nov. 15, 2017.
(60) Provisional application No. 62/723,722, filed on Aug. 28, 2018.

(51) Int. Cl. H04L 1/18; H04W 72/04

(52) U.S. Cl. CPC H04L 1/1819; H04L 1/1896; H04W 72/0446; H04W 72/0493; H04W 72/042; H04L 1/1854

(57) ABSTRACT

Methods, apparatuses, and systems are provided to determine the size of a Hybrid Automatic Repeat Request acknowledgement (HARQ-ACK) codebook to be transmitted over a physical uplink control channel (PUCCH). The HARQ-ACK codebook size may be determined by a wireless transmit/receive unit (WTRU) from the HARQ timing and/or counter downlink assignment index (DAI), or may be received in a downlink control information (DCI). HARQ-ACK resource determination may be based on the feedback timing. A WTRU may implicitly indicate the size of the HARQ-ACK codebook, and/or may fall back to a default HARQ-ACK codebook size.

### CROSS REFERENCE TO RELATED APPLICATIONS

This application claims the benefit of U.S. Patent Application No. 62/586,525, filed Nov. 15, 2017, and 62/723,722, filed Aug. 28, 2018, the contents of which are hereby incorporated by reference herein.

### BACKGROUND

Long term evolution (LTE) systems may support a hybrid automatic repeat request (HARQ) protocol where a transport block (TB) can be retransmitted upon request from a wireless transmit/receive unit (WTRU). The WTRU may report, for a given physical downlink shared channel (PDSCH) transmission, whether the reception has succeeded or not by sending an acknowledgement/negative acknowledgement (ACK/NACK). The WTRU may combine the retransmissions of a TB to increase the probability of successful decoding at each retransmission attempt.

In LTE, there may be a fixed timing relationship between the reception of a TB and the HARQ-ACK bit transmission. The timing depends on the duplex arrangement i.e. frequency division duplex (FDD)-based or time division duplex (TDD)-based arrangement. In FDD, the WTRU may report HARQ-ACK bit feedback in subframe n for a transport block received in subframe n−4. In TDD, the timing may depend on the uplink/downlink (UL/DL) configuration and on the subframe number on which the TB was received.

The Third Generation Partnership Program (3GPP) is working on the next generation of wireless systems, called “New Radio” (NR). The NR access technology is expected to support a number of use cases such as enhanced Mobile Broadband (eMBB), and ultra-high reliability and low latency communications (URLLC). Each use case comes with its own set of requirements of spectral efficiency, and low latency.

NR supports dynamic HARQ-ACK timing, where a timing to be applied for a given TB may be indicated dynamically to a WTRU using a downlink control information (DCI). The 5G Node B (gNB) may also configure a WTRU using higher layer signaling with a set of possible timing values. In addition, a WTRU may also be configured to multiplex feedbacks for a set of PDSCH transmissions. This set of PDSCHs may correspond to multiple TBs transmitted on different slots. While dynamic indications of HARQ-ACK timing provide flexibility, it is necessary to ensure that the WTRU and gNB have common interpretations of HARQ-ACK timing because the number of TBs for which a HARQ-ACK transmission reports feedback may change. Thus, in the event that a WTRU misdetects a DCI, for instance, the WTRU will not be able to determine the correct size of a multiplexed HARQ feedback that corresponds to multiple TBs. In this case, the gNB will misinterpret the feedback provided, and the resulting errors will likely affect reliability and latency.

### SUMMARY

Methods, apparatuses, and systems are provided for physical uplink control channel (PUCCH) codebook size determination. Hybrid automatic repeat request (HARQ) acknowledgement (HARQ-ACK) codebook size determination may be based on the HARQ timing and/or counter downlink assignment index (DAI). HARQ-ACK resource determination may be based on a timing window. A wireless transmit/receive unit (WTRU) may implicitly indicate the number of the HARQ-ACK codebook size, and may fallback to default HARQ-ACK codebook size.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram of a dynamic hybrid automatic repeat request (HARQ) acknowledgement (HARQ-ACK) timing indication in new radio (NR);

FIG. 3 is a diagram of a dynamic HARQ-ACK timing indication determined as an offset from the end of a Physical Downlink Shared Channel (PDSCH) transmission;

FIG. 4 is a diagram of a HARQ-ACK codebook determination based on counter DAI and HARQ timing and HARQ Feedback Size (HFS);

FIG. 5 is a diagram of a HARQ-ACK codebook determination based on counter downlink assignment index (DAI) and HARQ timing;

FIG. 6 is a flow diagram for determining the sequence of HARQ-ACK bits from counter DAI and HARQ timing; and

FIG. 7 is a diagram of an example method for a WTRU to receive multiple feedback size indicators.

### DETAILED DESCRIPTION

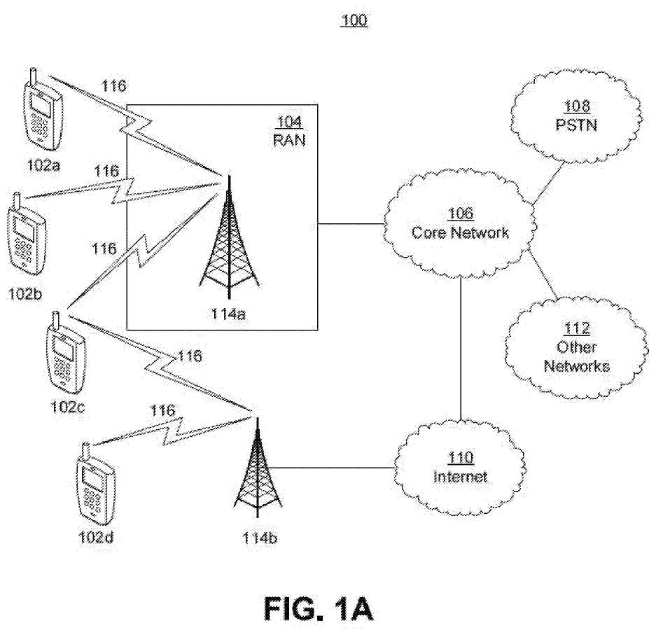

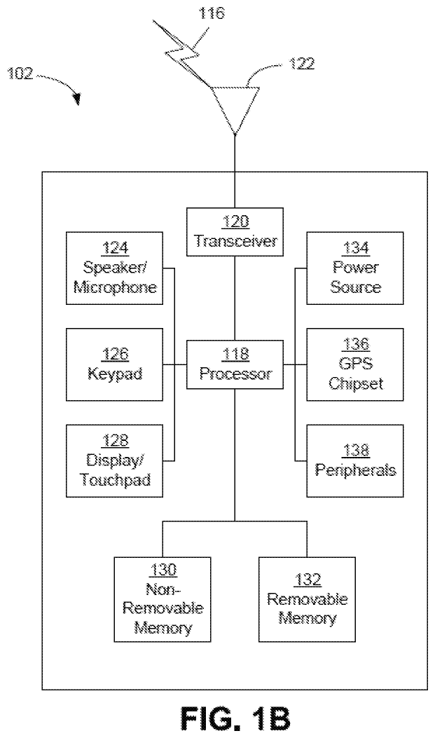

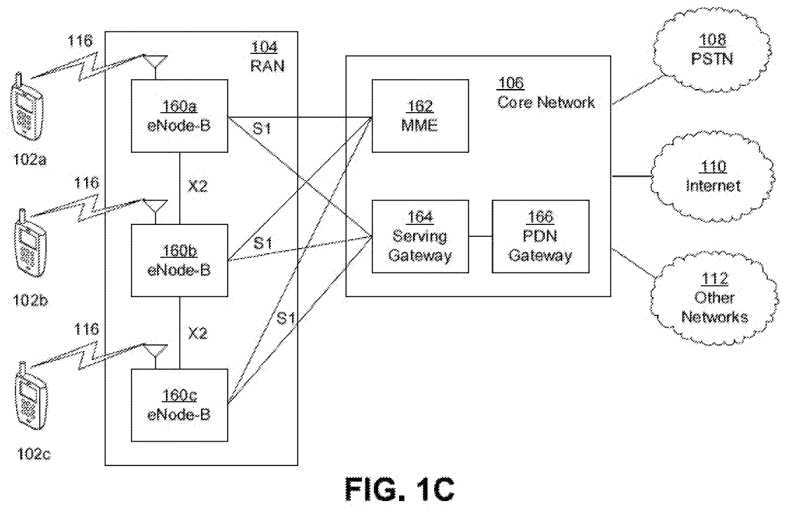

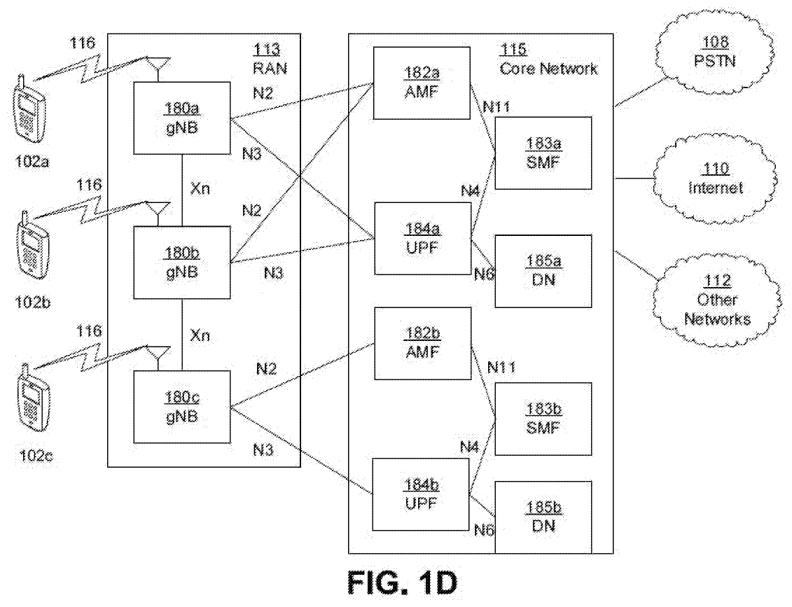

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, alaptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The methods and systems disclosed herein may be implemented in any one or more layers, such as Layer 1 (1) and layer 2/3 (L2/L3) and may be implemented in a WTRU and/or one or more network elements.

The following abbreviations and acronyms are used herein: sub-carrier spacing (Δf); 5G Flexible Radio Access Technology (5GFlex); 5GFlex NodeB (5gNB); Acknowledgement (ACK); Block Error Rate (BLER); Basic timing interval (BTI) (in integer multiple of one or more symbol duration); Contention-Based (CB) (e.g. access, channel, resource); Coordinated Multi-Point transmission/reception (CoMP); Cyclic Prefix (CP); Conventional OFDM (CP-OFDM) (e.g., relying on cyclic prefix); Channel Quality Indicator (CQI); Core Network (e.g. LTE packet core) (CN); Cyclic Redundancy Check (CRC); Channel State Information (CSI); Closed Subscriber Group (CSG); Device to Device transmissions (D2D) (e.g. LTE Sidelink); Downlink Control Information (DCI); Downlink (DL); Demodulation Reference Signal (DM-RS); Data Radio Bearer (DRB); Evolved Packet Core (EPC); Filtered Band Multi-Carrier (FBMC); Offset Quadrature Amplitude Modulation (OQAM); Frequency Division Duplexing (FDD); Frequency Division Multiplexing (FDM); Industrial Control and Communications (ICC); Inter-Cell Interference Cancellation (ICIC); Internet Protocol (IP); License Assisted Access (LAA); Listen-Before-Talk (LBT); Logical Channel (LCH); Logical Channel Prioritization (LCP); Low Latency Communications (LLC); Long Term Evolution (LTE) (e.g. from 3GPP LTE Release 8 (R8) and up); Medium Access Control (MAC); Negative ACK (NACK); Massive Broadband Communications (MBB); MultiCarrier (MC); Modulation and Coding Scheme (MCS); Multiple Input Multiple Output (MIMO); Machine-Type Communications (MTC); Non-Access Stratum (NAS); New Radio access technology (NR); Orthogonal Frequency-Division Multiplexing (OFDM); Out-Of-Band (emissions) (OOB); Prioritized Bit Rate (PBR); Total available WTRU power in a given TI (Pcmax); Physical Layer (PHY); Physical Random Access Channel (PRACH); Protocol Data Unit (PDU); Packet Error Rate (PER); Path Loss (Estimation) (PL); Public Land Mobile Network (PLMN); Packet Loss Rate (PLR); Primary Synchronization Signal (PSS); Quality of Service (QoS) (e.g., from the physical layer perspective); Radio Access Bearer (RAB); Random Access Channel or procedure (RACH); Radio Front end (RF); Radio Network Identifier (RNTI); Radio Resource Control (RRC); Radio Resource Management (RRM); Reference Signal (RS); Round-Trip Time (RTT); Single Carrier Multiple Access (SCMA); Service Data Unit (SDU); Sidelink (SL); Spectrum Operation Mode (SOM); Synchronization Signal (SS); Secondary Synchronization Signal (SSS); Signalling Radio Bearer (SRB); Switching Gap (SWG) (e.g., in a self-contained subframe); Transport Block (TB); Transport Block Size (TBS); Time-Division Duplexing (TDD); Time-Division Multiplexing (TDM); Time Interval (TI) (e.g., in integer multiple of one or more BTI); Transmission Time Interval (TTI) (e.g., in integer multiple of one or more TI); Transmission/Reception Point (TRP); TRP Group (TRPG); Transceiver (TRx); Universal Filtered MultiCarrier (UFMC); Universal Filtered OFDM (UF-OFDM); Uplink (UL); Ultra-Reliable Communications (URC); Ultra-Reliable and Low Latency Communications (URLLC); Vehicle to vehicle communications (V2V); and Vehicular communications (V2X).

NR may enable great flexibility. Such flexibility may enable a WTRU to multiplex, in the same resource, HARQ-ACK feedbacks of multiple TBs scheduled in different transmission occasions. Furthermore, NR may support dynamic HARQ feedback timing indication, where the network may dynamically change the ACK/NAK (A/N) feedback timing. Using a DCI, the network may have the full flexibility to change the feedback timing for each HARQ process and even for the same HARQ process when scheduling retransmissions.

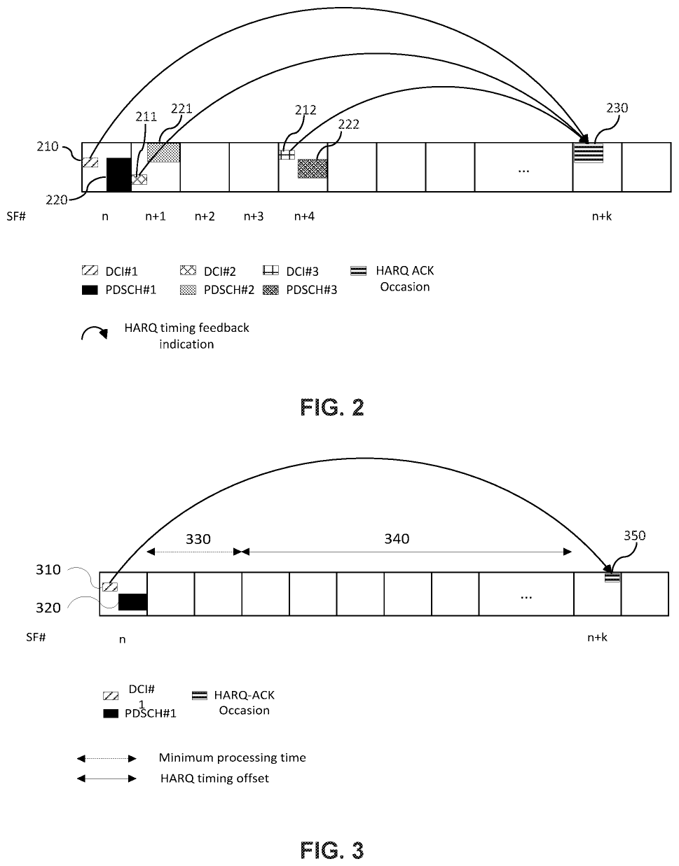

FIG. 2 is an example diagram of a set of dynamically configured HARQ-ACK feedback indications. A WTRU may receive, for example, three consecutive assignments in subframes n, n+1, and n+4. As illustrated in FIG. 2, the WTRU receives a first DCI 210 and corresponding PDSCH transmission 220 in subframe n, a second DCI 211 with corresponding PDSCH transmission 221 in subframe n+1, and a third DCI 212 with corresponding PDSCH transmission 222 in subframe n+4. The WTRU determines, based on DCI 210, 211, and 212, to report A/N feedback for each of subframes n, n+1, and n+4 within a single HARQ-ACK occasion 230 in subframe n+k.

Methods, apparatuses, and systems disclosed herein further support dynamic HARQ feedback timing by equipping the WTRU and the gNB with a common interpretation of the number and the order of HARQ ACKs or NACKS conveyed on a PUCCH transmission. Such common interpretations may improve reliability and latency in providing HARQ feedback, for instance, when a WTRU misdetects a DCI. In addition, embodiments disclosed herein provide a WTRU with uplink control resources adapted to such dynamicity while at the same time ensuring efficient resource utilization. It should also be noted that the embodiments disclosed herein may be applied independently, and may be applicable to, or used in combination with, other existing HARQ-ACK codebook size determination methods.

A WTRU may be configured to report feedback for a set of TBs that are transmitted on multiple timing occasions. The WTRU may make sure that the A/N bits ordered on the feedback payload correspond to the order assumed by the network.

According to the disclosures herein, the resources for HARQ A/N feedback may be determined in the time domain. In an example, a WTRU may be configured to determine the resources for HARQ-ACK feedback transmission based on the configured HARQ feedback timing. The feedback timing may be dynamically indicated by a DCI that schedules at least one TB. Alternatively, the feedback timing may be semi-statically configured using higher layer signaling or a combination of dynamic and semi-static configuration. The resources may include a PUSCH or a PUCCH transmission. The WTRU may first determine the timing of the resources, for instance, in terms of slot, mini-slot or starting symbol. At least in the case that a PUSCH transmission is not scheduled for this timing, the WTRU may determine that HARQ-ACK feedback is transmitted over a PUCCH resource. The PUCCH resources and format may be determined from a DCI scheduling at least one TB. For example, the PUCCH resources and/or format may be indicated by an A/N resource indicator (ARI) field in the DCI. In the case that a PUSCH transmission is scheduled for the timing, and/or if the WTRU determines that the HARQ-ACK feedback is allowed to be transmitted over PUSCH resources, the WTRU may determine that HARQ-ACK feedback is encoded and transmitted over the PUSCH transmission.

According to the disclosures herein, a set of HARQ-ACK occasions may be semi-statically or dynamically configured. In an example, the WTRU may be configured with a set of occasions in the time domain for the transmission of HARQ-ACK feedback for TBs scheduled by at least one DCI. Such occasions may be referred to as a “HARQ-ACK occasion.” The set of HARQ-ACK occasions may be configured semi-statically. For example, the set of occasions may occur periodically or according to a UL/DL subframe configuration. For some configurations (e.g., for FDD operation), the set of occasions may comprise all slots. The set of occasions may depend on the type of transmission over which HARQ-ACK is transmitted, such as whether the transmission is over PUSCH or PUCCH, or on the PUCCH format (e.g., short or long format).

In another example, a HARQ-ACK occasion may be indicated dynamically, and may be indicated in combination with a higher layer configuration. For example, a HARQ-ACK occasion may be indicated by a DCI obtained from a PDCCH or a group-common PDCCH. In another example, the WTRU may determine that a HARQ-ACK occasion is present in a time resource if this time resource is part of a semi-statically indicated set of HARQ-ACK occasions (if such set is defined) and if a PDCCH or group-common PDCCH indicates that the time resource is available for uplink transmission (e.g., from a slot format indication (SFI)). In another example, a HARQ-ACK occasion may be explicitly indicated by a DCI indicating the availability of the HARQ-ACK occasion and corresponding resource. The timing of such resource may be offset by a number of slots after reception of the DCI, where the number may be pre-defined (e.g. zero), configured by higher layers, or indicated from the DCI. For example, the indication may be derived from an A/N resource indicator or timing offset field.

The WTRU may determine the timing of HARQ-ACK for at least one TB based on the DCI scheduling such corresponding TB or TBs. For example, the WTRU may determine the timing as a function of at least one of several possible aspects of the DCI. The timing may be determined, for instance, according to a field included in the DCI, such as an A/N resource indicator (ARI) that may jointly indicate a PUCCH resource, or a separate field (e.g. A/N Timing). Such separate field may be referred to as a “timing” field. The timing of the HARQ-ACK may also depend on the timing of the DCI with respect to a subframe or slot boundary (e.g. a slot index or symbol index). The timing may depend on the cell, cell group or bandwidth part from which the corresponding PDCCH is decoded. The timing may be determined based on a control resource set (CORESET) from which the corresponding PDCCH is decoded or a property thereof, such as a number of symbols in the time domain, and whether the CORESET starts from the first symbol of the slot or from another symbol or a monitoring period. In addition, the timing may be determined from any combination of a HARQ process ID; a transmission profile; the duration of the scheduled PDSCH (e.g. in symbols); the subcarrier spacing and/or symbol duration of the PDSCH or PDCCH; the search space from which the PDCCH was decoded, or the aggregation level thereof.

FIG. 3 shows an example in which the timing of HARQ-ACK is determined as an offset from the timing of the DCI. In this example, the offset may be in units of symbols, slots or subframes, or number of HARQ-ACK occasions following the DCI. In FIG. 3, a DCI 310 is received that includes information for receiving a PDSCH 320. The timing of the HARQ-ACK occasion 350 is determined based on a first parameter representing a minimum processing time 330 and a second parameter representing an additional offset 340 that is obtained from the DCI 310, e.g. from a timing field. The timing of the HARQ-ACK occasion 350 may be determined as the point in time following at least one of: the minimum processing time 330 after reception of the DCI 310; and/or the minimum processing time after the start or the end of the PDSCH transmission 320. In other embodiments, the specific HARQ-ACK occasion may be determined by one of several parameters pertaining to multiple additional offset values. For example, one value may indicate the first HARQ-ACK occasion, and a second value may indicate the second HARQ-ACK occasion, etc. In another example, the additional offset may first be added to the minimum processing time. In the above, the first parameter may be configured by higher layers. The second parameter may indicate one of a set of timing offsets configured by higher layers. The configuration may be specific to a serving cell, cell group, bandwidth part and/or CORESET from which the DCI is decoded. The first and second parameters may be in units of slots, symbols, or HARQ-ACK occasions.

In another example, a WTRU may transmit feedback in a HARQ-ACK occasion for TBs that are received on a preconfigured window M. For example, the WTRU may be configured with a HARQ-ACK occasion x on every n^{th} subframe or slot n. The WTRU may report HARQ feedback for all TBs received in a window. Such a window may be defined by slots that begin at a first offset position from the HARQ-ACK occasion and end at a second offset position from the HARQ-ACK occasion. For example, in a HARQ-ACK occasion transmitted in slot n, a WTRU may include HARQ feedback for any transport block transmitted between slots n-M and n. In another example, the HARQ feedback transmission in a HARQ-ACK occasion may include feedback for any TB transmitted in the window and for which the HARQ feedback timing points to slot n.

In an example case, a HARQ-ACK occasion may be used to report HARQ feedback for a window of size M. In this case, the codebook size of the feedback report may be semi-statically set to M or a multiple of M (e.g. for the case of spatial multiplexing). The WTRU may be configured to transmit NACK for any transmission occasion in the window during which no PDSCH was scheduled and/or received. In another solution, the codebook size may be dynamic and be up to size M or a multiple of M. Such HARQ-ACK occasion may be used to report A/N feedback for only the TBs that are scheduled by a subset of CORESETs within the window M. For example, during the window M, a WTRU may be configured to monitor N1 CORESETs. Based on a pre-configured rule, the WTRU may select N2≤N1 to use the same HARQ-ACK codebook, where N2 represents a subset of the N1 CORESETs scheduling TBs for which A/N feedback will be reported. Such rule may depend on one or more characteristics. For instance, the rule may take into account the type of traffic (e.g., URLLC or eMBB) which may be implicitly or explicitly indicated by the scheduling DCI. The rule may depend on the reliability requirement of the TB scheduled by the CORESET; and/or the transmission mode of the scheduled TB in terms of single/multiple antenna(s) and/or diversity scheme. In addition, the rule may account for the periodicity of CORESET monitoring; the time location of the CORESET within a slot and/or the transmission mode of the CORESET, such as the interleaving method and/or resource element group (REG) bundling.

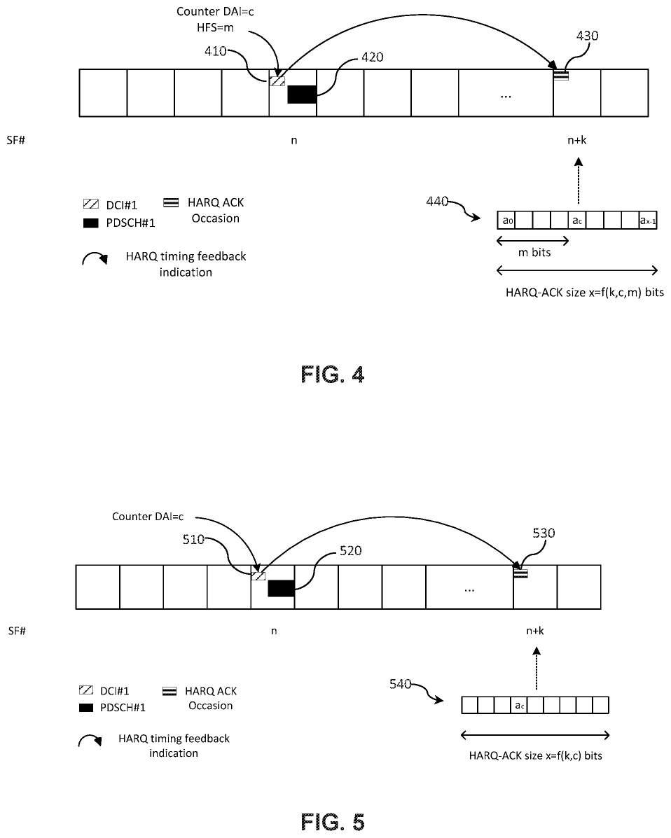

FIG. 4 shows an example in which the WTRU is configured to determine the size of an A/N report (i.e., the number of TBs for which the WTRU will provide HARQ-ACK feedback) based on the configured HARQ feedback timing. The WTRU receives a TB on subframe/slot n with a DCI 410 scheduling a HARQ-ACK occasion 430 for a corresponding PDSCH transmission 420. The DCI 410 indicates that the HARQ-ACK occasion 430 has timing equal to k. The WTRU then assumes that the payload 440 of the feedback 430 to be reported on subframe/slot n+k is equal to x=f(k). The function may depend on the slot n of one of the TBs (e.g., the first in time) whose HARQ-ACK is to be included in a report. Such function may be based on a formula or a table that links feedback timing to an expected feedback size. The table may be semi-statically configured, fixed, or dynamically indicated.

FIG. 5 shows an example in which the WTRU receives a HARQ Feedback Size (HFS) indication and determines the number of bits that should be reported based on such HFS indication. The WTRU receives a first DCI 510 in subframe/slot n scheduling a DL transmission 520 with HARQ timing k and HFS=m. The WTRU may determine the size of feedback to be reported in subframe/slot n+k to be equal to x=f(k) (or x=f(k,m)) and put the A/N bit of the transmission on the first index. Using HFS indication, the WTRU creates a codebook 540 of size m and attempts to populate the codebook 540 until such time as m scheduling occasions have occurred, or m scheduling events have occurred, or the PUCCH resource is scheduled. In other embodiments, the HFS may be included in some or all of the DCI used for downlink scheduling and for which the feedback is transmitted in the same HARQ-ACK occasion.

In another example, the WTRU may rely on a total Downlink Assignment Index (DAI) or codebook size indicator to determine the number of feedback bits that the network is expecting for a given subframe/slot. The terms “total DAI” and “counter DAI” discussed herein may have a different meaning than that described in 3GPP specifications. This distinction may arise, for instance, in the case that the scheduler knows the number of TBs to be scheduled for subsequent subframes, up to the indicated HARQ feedback timing. In such scenarios, the total DAI may not be transmitted on every scheduling assignment. The scheduler may implicitly or explicitly indicate to the WTRU whether total DAI is transmitted or not. For example, the scheduler may use a different DCI format/size depending on the availability of the total DAI. In other examples, the scheduler may use a bit field in the DCI that is always transmitted, and insert, for example, all zeros to indicate that the total DAI is not transmitted. The WTRU may use such information to reduce the number of blind decoding attempts if no scheduling TBs are expected. For example, a total DAI may indicate k transmissions; if the WTRU receives the corresponding TBs, the WTRU may reduce the number of blind decoding attempts that it would otherwise undertake until the scheduled HARQ feedback timing.

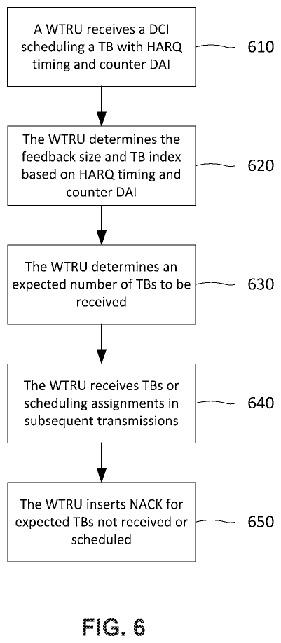

FIG. 6 shows an example in which the WTRU determines the size of the HARQ feedback based on the counter DAI and the indicated feedback timing. The WTRU receives a TB in subframe n with a DCI 610 that schedules a HARQ-ACK occasion 630 for a corresponding PDSCH transmission 620. The DCI 610 indicates that the HARQ-ACK occasion 630 has timing equal to k. The corresponding counter DAI indicated by the network is equal to c. The WTRU then assumes that the payload 640 of the feedback 630 to be reported in subframe n+k is equal to x=f(k,c). The values for total DAI and counter DAI may each be defined per UCI resource and/or per time window.

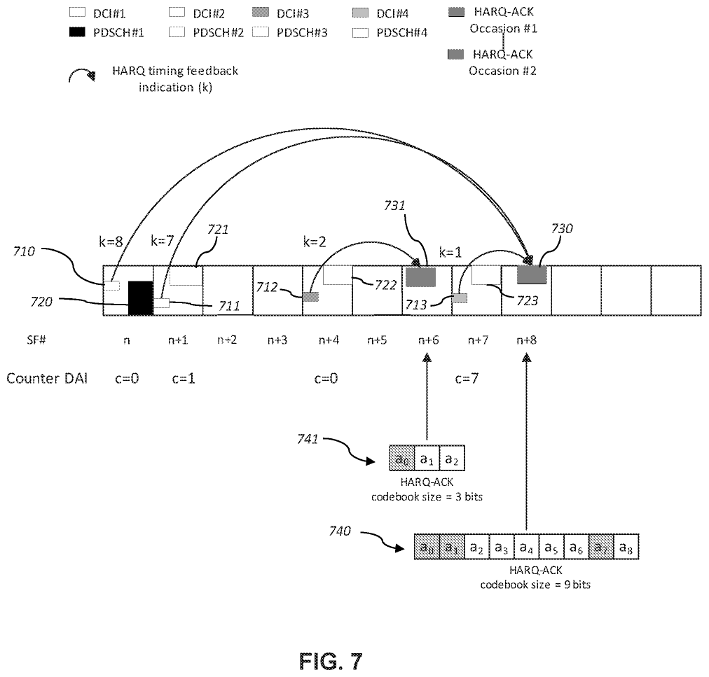

FIG. 7 shows an example in which the WTRU determines the size of the HARQ feedback based on one or both of a HFS indication or counter DAI and indicated feedback timing. As in FIG. 5, above, the WTRU receives a first DCI 710 in subframe/slot n scheduling a DL transmission 720 with HARQ timing k and HFS=m. The WTRU may determine the size of feedback to be reported in subframe/slot n+k to be equal to x=f(k) or x=f(k, m) and put the A/N bit of the transmission on the first index. Using HFS indication, the WTRU creates a codebook 740 of size m and attempts to populate the codebook 740 until such time as m scheduling occasions have occurred, or m scheduling events have occurred, or the PUCCH resource is scheduled. As in FIG. 6 above, the DCI 710 may also indicate that the corresponding counter DAI indicated by the network is equal to c. In that case, the WTRU may assume that the payload 740 of the feedback 730 to be reported in subframe n+k is equal to x=f(k,c), or x=f(k, c, m).

In accordance with the disclosures herein, the sequence of HARQ-ACK bits may be determined. In an example, the WTRU may determine from the counter DAI and/or the HARQ timing that it is missing one or more assignments and may then determine the sequence of HARQ feedback bits to be reported for a given subframe. In an example, the WTRU may assume that an assignment was missed and that corresponding A/Ns are inserted, in case at least one (or both) of the following conditions are satisfied: the DAI was not incremented by one; and/or the assignments are not applicable to the same TB.

FIG. 8 is a flowchart providing an example set of steps by which a WTRU determines the sequence of HARQ-ACK bits based on counter DAI and HARQ-ACK timing. In step 810, the WTRU receives a DCI scheduling a TB with HARQ timing equal to k and counter DAI equal to 0. In step 820, the WTRU determines the feedback size N1=f(k,0) and assumes that this TB has an index 0. At step 830, the WTRU expects to receive up to (N1-1) TBs on subsequent transmission occasions. At step 840, WTRU receives the subsequent transmissions. Regardless of whether the WTRU receives or is scheduled for the expected TBs, the WTRU may report N1 bits HARQ feedback. Thus, in step 850, in case the WTRU does not receive a scheduling assignment or is not scheduled for one or more of the expected TBs, the WTRU reports NACK for each TB not received or not scheduled. In another example, the WTRU may receive a DCI scheduling a TB with HARQ timing equal to k and counter DAI equal to 1. The WTRU may then determine the feedback size N2=f(k,1) and may assume that this TB has an index 1. The WTRU may transmit NACK in the index 0 and may assume that a DCI was missed.

In another example, the WTRU may be configured with a function N=f(k,c), where N may be the number of feedback bits, k may be the HARQ timing, c may be the counter DAI value, and the function f( ) may be defined using a table, such as Table 1. In Table 1, the number of feedback bits N may be determined by selecting a value for the HARQ timing, k, and a counter DAI value, c. For example, for k=2 and c=4, N takes the value of f(2, 4)=7, as determined from Table 1.

TABLE 1
Example function N = f(k, c)

| | | Counter DAI (c) | | | | | | | |
|---|---|---|---|---|---|---|---|---|---|
| | | 0 | 1 | 2 | 3 | 4 | 5 | 6 | 7 |
| HARQ | 0 | 1 | 2 | 3 | 4 | 5 | 6 | 7 | 8 |
| Timing | 1 | 2 | 3 | 4 | 5 | 6 | 7 | 8 | 9 |
| (k) | 2 | 3 | 4 | 5 | 6 | 7 | 8 | 9 | 10 |
| | 3 | 4 | 5 | 6 | 7 | 8 | 9 | 10 | 11 |
| | 4 | 5 | 6 | 7 | 8 | 9 | 10 | 11 | 12 |
| | 5 | 6 | 7 | 8 | 9 | 10 | 11 | 12 | 13 |
| | 6 | 7 | 8 | 9 | 10 | 11 | 12 | 13 | 14 |
| | 7 | 8 | 9 | 10 | 11 | 12 | 13 | 14 | 15 |
| | 8 | 9 | 10 | 11 | 12 | 13 | 14 | 15 | 16 |

FIG. 9 is a diagram of an example method for a WTRU to receive multiple feedback size indicators. In the example of FIG. 9, the WTRU receives, in subframe number (SF #) n, a first PDSCH 920 and a first DCI 910 indicating the corresponding HARQ feedback 930 has timing k=8 and counter DAI c=0. The WTRU determines the size of the HARQ-ACK codebook 940 according to the function N=f(k,c), for example, using the values in Table 1. In this case, the WTRU determines that Nₙ₊₈=9, which implies that the codebook 940 to be used at subframe n+8 has size N=9. The WTRU also attempts to decode the first PDSCH 920 and determine whether an ACK or NACK should be transmitted.

The WTRU receives a second PDSCH 921 and a second DCI 911 in subframe n+1, and determines the characteristics of the corresponding HARQ-ACK codebook. In this case, the WTRU determines that k=7 and counter DAI c=1, and thus the HARQ-ACK information is to be transmitted at subframe n+8 (i.e., the same time at which HARQ-ACK occasion 930 is transmitted for the previously received PDSCH 920). The WTRU determines, using Table 1, that the size of codebook 940 has not changed because Nₙ₊₈=f(7,1)=9. The WTRU also attempts to decode the second PDSCH 921 and determine whether an ACK or NACK should be transmitted.

At subframe n+4, the WTRU receives a third DCI, and may determine the characteristics of the corresponding HARQ-ACK codebook. In this case, the WTRU determines that the corresponding HARQ feedback 931 has timing k=2 and counter DAI c=0, and thus the HARQ-ACK codebook 941 for this transmission is transmitted at subframe n+6 (i.e., not at the same time as the other HARQ-ACK codebook transmission determined in subframes n and n+1). The WTRU determines the size of the codebook 941 based on Table 1 to be Nₙ₊₆=3. The WTRU attempts to decode the third PDSCH 922 and determine whether an ACK or NACK should be transmitted within HARQ feedback 931.

In another example, the function N=f(k,c) may be implemented using a formula and may not use a table. For example, the entries in the table may be calculated using the formula N=c+k+1, and thus the number of feedback bits N may be calculated from the formula. In other examples, the function f( ) may be implemented using a lookup table or a formula.

With reference to FIG. 9, at subframe n+6, the WTRU transmits the codebook 941 of size 3 bits carrying the HARQ-ACK information for the third PDSCH 922.

At subframe n+7, the WTRU receives a fourth DCI 923, and determines the characteristics of the corresponding HARQ-ACK codebook. In this case, the WTRU determines that the corresponding HARQ feedback has timing k=1 and counter DAI c=7, and thus the HARQ-ACK information is to be transmitted at subframe n+8 (i.e., the same time at which HARQ-ACK occasion 930 is transmitted for the previously received PDSCHs 920 and 921). The WTRU determines that the size of codebook 940 has not changed because Nₙ₊₈=f(1,7)=9. The WTRU attempts to decode the fourth PDSCH 923 and determine whether an ACK or NACK should be transmitted.

At subframe n+8, the WTRU transmits the codebook 940 with a size of 9 bits carrying the HARQ-ACK information for PDSCH 920, PDSCH 921 and PDSCH 923.

An advantage of the approach used in FIG. 9, particularly for subframe n+8 in this example, is that if the WTRU misses one of the DCI 910, 911 or 913, the WTRU may still transmit a HARQ-ACK codebook with a size of 9 bits at the subframe n+8 for the feedback. This approach reduces the risk of the WTRU not being synchronized with the network with respect to HARQ-ACK codebook size. This is true regardless of which of the DCI is missed (e.g., the first, the last, or the middle DCI). According to this approach, the network may determine the size of the codebook to be transmitted at subframe n+k at the first transmission that leads to HARQ-ACK feedback during that subframe.

According to the approach used in FIG. 9, the WTRU determines the order of the feedback bits according to the counter DAI index. Thus, in the example of FIG. 9, the feedback for PDSCH 910 is in the first bit position (a₀), the feedback for PDSCH 911 is in the second bit position (a), and the feedback for PDSCH 913 is in the 8^{th} bit position (a₇) of the 9 bits HARQ-ACK codebook 940 to be transmitted in subframe n+8. For the other bit positions, the WTRU may not know whether a transmission was missed. The WTRU may thus be configured to insert a “NACK” for those bit positions to indicate that nothing has been received (e.g., NACKS in bits a₁ and a₂ for the first codebook in subframe n+6, and bits a₂-a₆ and as for the second codebook in subframe n+8).

The codebook size may be determined based on indications that the WTRU has misdetected a DCI. In accordance with the disclosures herein, the WTRU may indicate the selected feedback size. The WTRU may use the methods described hereafter based on, for example, whether the network transmits the total DAI, the counter DAI, or neither. In an example, the WTRU may be configured to indicate the first counter DAI that has been detected. The network may then interpret the HARQ feedback correctly. Such indication may be transmitted along with feedback, in a separate channel, or implicitly detected using, for example, channel selection. For example, the WTRU may indicate the first detected counter DAI c and, based on the function f(k,c) described above, the network may determine the size and the order accordingly. For instance, a codebook may include x bits in a fixed position (e.g. the first x bits) to indicate that the WTRU detected the first counter DAI successfully. This may help in the event that a WTRU is expected to provide feedback in a codebook that has a size dependent on the slot of the first DCI with respect to the PUCCH slot. In such a case, the WTRU may not be aware of the slot of the first DCI and may thus be unable to determine the intended codebook size.

In another example, the WTRU may be configured to transmit one bit flag to indicate whether one or more assignments have been missed at the beginning of the window. The network may then perform blind decoding to determine the correct size of the feedback. For example, if a DAI of x bits is used in each DCI, the WTRU may determine if the first DCI is missing. This may trigger the WTRU to set the bit flag to indicate that at least one DCI is missing from the beginning of the window. The network may then attempt 2^{x}-1 blind detection to account for all possible codebook sizes in the event that the WTRU missed up to 2^{x}-1 DCI.

In other solutions, the WTRU may fall back to a default feedback payload size. Such a default size can be tied to frame size and/or system frame number (SFN). For example, in the context of a frame containing 10 subframes or slots, the WTRU may switch to a default size of 10 bits when the WTRU determines that X DCI have been missed. Each bit represents a potential missed DCI on every subframe or slot. The default size may be a function of the configured CORESETs/search spaces periodicity and/or the type of traffic (e.g. URLLC/eMBB).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a New Radio (NR) system, the method comprising:
receiving a plurality of transport blocks (TBs), wherein the plurality of TBs are received in different transmission occasions;
determining a first resource for a hybrid automatic repeat request (HARQ) acknowledgement (HARQ-ACK) feedback transmission based on at least a feedback timing, wherein the first resource is for a physical uplink shared channel (PUSCH) or a physical uplink control channel (PUCCH) transmission, and wherein the feedback timing includes a set of HARQ-ACK occasions in a time domain for transmission of the HARQ-ACK feedback;
determining a codebook size of the HARQ-ACK feedback based on the feedback timing or a combination of the feedback timing and a counter downlink assignment index (DAI);
multiplexing, in the first resource, the HARQ-ACK feedback of the plurality of TBs; and
transmitting the HARQ-ACK feedback of the plurality of TBs in the first resource.

2. The method of claim 1, wherein the feedback timing is determined based on at least one of dynamic indication by downlink control information (DCI) scheduling at least one TB; or semi-static configuration by higher layer signaling.

3. The method of claim 1, wherein determining the resource for the HARQ-ACK feedback transmission further includes:
determining a timing of the HARQ-ACK feedback transmission as a function of at least one of: a field in a downlink control information (DCI); an acknowledgement/negative acknowledgement (A/N) resource indicator (ARI); a timing of the DCI to a subframe or slot boundary; a cell, cell group, or bandwidth part from which a corresponding physical downlink control channel (PDCCH) is decoded; a control resource set (CORESET) from which a corresponding PDCCH is decoded, or a property thereof: a HARQ process identifier (ID); a transmission profile; a duration of a scheduled physical downlink shared channel (PDSCH); a subcarrier spacing and/or symbol duration of the PDSCH or PDCCH; or a search space from which PDCCH was decoded or an aggregation level thereof.

4. The method of claim 1, wherein determining the resource for the HARQ-ACK feedback transmission further includes:
monitoring one or more CORESETs within a preconfigured time window;
selecting a subset of the CORESETs based on at least one of: a type of traffic specified, a required reliability and/or transmission mode for TBs scheduled by the CORESETs, a periodicity of CORESET monitoring, a timing of the CORESETs within a slot, or a transmission mode of the CORESETs; and
scheduling reporting of HARQ-ACK feedback for TBs scheduled by the selected CORESETs within the preconfigured time window in a single HARQ-ACK feedback occasion;
and wherein determining a codebook size of the HARQ-ACK feedback is further determined based on the number of TBs scheduled by the selected subset of CORESETs.

5. The method of claim 1, further comprising:
transmitting the codebook size of the HARQ-ACK feedback.

6. The method of claim 1, wherein determining a codebook size of the HARQ-ACK feedback includes falling back to a default HARQ-ACK codebook size.

7. The method of claim 1, wherein determining a codebook size of the HARQ-ACK feedback includes using a lookup table.

8. The method of claim 1, wherein determining a codebook size of the HARQ-ACK feedback includes calculating a function of at least a number of feedback bits, a value of the feedback timing, and a value of the counter DA.

9. A wireless transmit/receive unit (WTRU) comprising:
a receiver configured to receive a plurality of transport blocks (TBs), wherein the plurality of TBs are received in different transmission occasions;
a processor configured to:
determine a first resource for the hybrid automatic repeat request (HARQ) acknowledgement (HARQ-ACK) feedback transmission based on at least a feedback timing, wherein the first resource is for a physical uplink shared channel (PUSCH) or a physical uplink control channel (PUCCH) transmission, and wherein the feedback timing includes a set of HARQ-ACK occasions in a time domain for transmission of the HARQ-ACK feedback;
determine a codebook size of the HARQ-ACK feedback based on at least one of the feedback timing or a counter downlink assignment index (DAI);
multiplex, in the first resource, the HARQ-ACK feedback of the plurality of TBs; and
a transmitter configured to transmit the HARQ-ACK feedback of the plurality of TBs in the first resource.

10. The WTRU of claim 9, wherein the processor is further configured to determine the feedback timing based on at least one of: dynamic indication by downlink control information (DCI) scheduling at least one TB; or semi-static configuration by higher layer signaling.

11. The WTRU of claim 9, wherein the processor is further configured to determine the resource for the HARQ-ACK feedback transmission by:
determining a timing of the HARQ-ACK feedback transmission as a function of at least one of: a field in a downlink control information (DCI); an acknowledgement/negative acknowledgement (A/N) resource indicator (ARI); a timing of the DCI to a subframe or slot boundary; a cell, cell group, or bandwidth part from which a corresponding physical downlink control channel (PDCCH) is decoded; a control resource set (CORESET) from which a corresponding PDCCH is decoded, or a property thereof: a HARQ process identifier (ID); a transmission profile; a duration of a scheduled physical downlink shared channel (PDSCH); a subcarrier spacing and/or symbol duration of the PDSCH or PDCCH; or a search space from which PDCCH was decoded or an aggregation level thereof.

12. The WTRU of claim 9, wherein the processor is further configured to determine the resource for the HARQ-ACK feedback transmission by:
monitoring one or more CORESETs within a preconfigured time window;
selecting a subset of the CORESETs based on at least one of: a type of traffic specified, a required reliability and/or transmission mode for TBs scheduled by the CORESETs, a periodicity of CORESET monitoring, a timing of the CORESETs within a slot, or a transmission mode of the CORESETs; and
scheduling reporting of HARQ-ACK feedback for TBs scheduled by the selected CORESETs within the preconfigured time window in a single HARQ-ACK feedback occasion;
and wherein the processor is further configured to determine a codebook size of the HARQ-ACK feedback based on the number of TBs scheduled by the selected subset of CORESETs.

13. The WTRU of claim 9, wherein the transmitter is further configured to transmit the codebook size of the HARQ-ACK feedback.

14. The WTRU of claim 9, wherein the processor is further configured to determine a codebook size of the HARQ-ACK feedback by falling back to a default HARQ-ACK codebook size.

15. The WTRU of claim 9, wherein the processor is further configured to determine a codebook size of the HARQ-ACK feedback by using a lookup table.

16. The WTRU of claim 9, wherein the WTRU is further configured to determine a codebook size of the HARQ-ACK feedback by calculating a function of at least a number of feedback bits, a value of the feedback timing, and a value of the counter DAI.
